(19) United States
(12) Patent Application Publication
(10) Pub. No.: US 2016/0350652 A1
(43) Pub. Date: Dec. 1, 2016

(54) DETERMINING EDIT OPERATIONS FOR NORMALIZING ELECTRONIC COMMUNICATIONS USING A NEURAL NETWORK

(71) Applicants: North Carolina State University, Raleigh, NC (US); SAS Institute Inc., Cary, NC (US)

(72) Inventors: Wookhee Min, Raleigh, NC (US); Samuel Paul Leeman-Munk, Raleigh, NC (US); Bradford Wayne Mott, Apex, NC (US); James Curtis Lester, II, Raleigh, NC (US); James Allen Cox, Cary, NC (US)

(21) Appl. No.: 14/967,619

(22) Filed: Dec. 14, 2015

Related U.S. Application Data
(60) Provisional application No. 62/168,295, filed on May 29, 2015.

(51) Int. Cl. G06N 3/08; G06N 3/04

(52) U.S. Cl. CPC G06N 3/08; G06N 3/04

(57) ABSTRACT

A neural network can be used to determine edit operations for normalizing an electronic communication. For example, an electronic representation of multiple characters that form a noncanonical communication can be received. It can be determined that the noncanonical communication is mapped to at least two canonical terms in a database. A recurrent neural network can be used to determine one or more edit operations usable to convert the noncanonical communication into a normalized version of the noncanonical communication. In some examples, the one or more edit operations can include inserting a character into the noncanonical communication, deleting the character from the noncanonical communication, or replacing the character with another character in the noncanonical communication. The noncanonical communication can be transformed into the normalized version of the noncanonical communication by performing the one or more edit operations.

### REFERENCE TO RELATED APPLICATION

This claims the benefit of priority under 35 U.S.C. §119(e) to U.S. Provisional Patent Application No. 62/168,295, titled “A Deep Contextual Long-Short Term Memory Model for Text Normalization” and filed May 29, 2015, the entirety of which is hereby incorporated by reference herein.

### TECHNICAL FIELD

The present disclosure relates generally to normalizing electronic communications. More specifically, but not by way of limitation, this disclosure relates to determining edit operations for normalizing electronic communications using a neural network.

### BACKGROUND

With the rise of the Internet and mobile electronic devices, users are generating increasing amounts of electronic content. Electronic content often takes the form of forum posts, text messages, social networking posts, blog posts, e-mails, or other electronic communications. In many cases, electronic content can include shorthand words, slang, acronyms, misspelled words, repeated characters, phonetic substitutions, incorrect grammar, and other informalities.

### SUMMARY

In one example, a computer readable medium comprising program code executable by a processor is provided. The program code can cause the processor to receive an electronic representation of a plurality of characters that form a noncanonical communication. The program code can cause the processor to determine that the noncanonical communication is mapped to at least two canonical terms in a database. The program code can cause the processor to determine, using a recurrent neural network, one or more edit operations usable to convert the noncanonical communication into a normalized version of the noncanonical communication. The program code can cause the processor to transform the noncanonical communication into the normalized version of the noncanonical communication by performing the one or more edit operations. The one or more edit operations can comprise inserting a character into the noncanonical communication, deleting the character from the noncanonical communication, or replacing the character with another character in the noncanonical communication. The recurrent neural network can comprise a plurality of input-to-hidden connections for transforming input data into transformed input data and providing the transformed input data to a hidden layer at a current time step. The recurrent neural network can comprise a plurality of hidden-to-hidden connections for transforming a hidden state of the hidden layer at a previous time step into a transformed hidden state and providing the transformed hidden state to the hidden layer at the current time step. The recurrent neural network can comprise a plurality of hidden-to-output connections for transforming the hidden state of the hidden layer at the current time step into a different transformed hidden state and transmitting the different transformed hidden state to an output layer at the current time step. The recurrent neural network can be configured to determine the normalized version of the noncanonical communication based on context information comprising a previous sequence of characters positioned immediately prior to the noncanonical communication in the plurality of characters and a later sequence of characters positioned immediately following the noncanonical communication in the plurality of characters.

In another example, a method is provided that can include receiving an electronic representation of a plurality of characters that form a noncanonical communication. The method can include determining that the noncanonical communication is mapped to at least two canonical terms in a database. The method can include determining, using a recurrent neural network, one or more edit operations usable to convert the noncanonical communication into a normalized version of the noncanonical communication. The method can include transforming the noncanonical communication into the normalized version of the noncanonical communication by performing the one or more edit operations. The one or more edit operations can comprise inserting a character into the noncanonical communication, deleting the character from the noncanonical communication, or replacing the character with another character in the noncanonical communication. The recurrent neural network can comprise a plurality of input-to-hidden connections for transforming input data into transformed input data and providing the transformed input data to a hidden layer at a current time step. The recurrent neural network can comprise a plurality of hidden-to-hidden connections for transforming a hidden state of the hidden layer at a previous time step into a transformed hidden state and providing the transformed hidden state to the hidden layer at the current time step. The recurrent neural network can comprise a plurality of hidden-to-output connections for transforming the hidden state of the hidden layer at the current time step into a different transformed hidden state and transmitting the different transformed hidden state to an output layer at the current time step. The recurrent neural network can be configured to determine the normalized version of the noncanonical communication based on context information comprising a previous sequence of characters positioned immediately prior to the noncanonical communication in the plurality of characters and a later sequence of characters positioned immediately following the noncanonical communication in the plurality of characters.

In another example, a system is provided that can include a processing device and a memory device. The memory device can include instructions executable by the processing device for causing the processing device to receive an electronic representation of a plurality of characters that form a noncanonical communication. The instructions can cause the processing device to determine that the noncanonical communication is mapped to at least two canonical terms in a database. The instructions can cause the processing device to determine, using a recurrent neural network, one or more edit operations usable to convert the noncanonical communication into a normalized version of the noncanonical communication. The instructions can cause the processing device to transform the noncanonical communication into the normalized version of the noncanonical communication by performing the one or more edit operations. The one or more edit operations can comprise inserting a character into the noncanonical communication, deleting the character from the noncanonical communication, or replacing the character with another character in the noncanonical communication. The recurrent neural network can comprise a plurality of input-to-hidden connections for transforming input data into transformed input data and providing the transformed input data to a hidden layer at a current time step. The recurrent neural network can comprise a plurality of hidden-to-hidden connections for transforming a hidden state of the hidden layer at a previous time step into a transformed hidden state and providing the transformed hidden state to the hidden layer at the current time step. The recurrent neural network can comprise a plurality of hidden-to-output connections for transforming the hidden state of the hidden layer at the current time step into a different transformed hidden state and transmitting the different transformed hidden state to an output layer at the current time step. The recurrent neural network can be configured to determine the normalized version of the noncanonical communication based on context information comprising a previous sequence of characters positioned immediately prior to the noncanonical communication in the plurality of characters and a later sequence of characters positioned immediately following the noncanonical communication in the plurality of characters.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

The present disclosure is described in conjunction with the appended figures:

FIG. 1 is a block diagram of an example of the hardware components of a computing system according to some aspects.

FIG. 2 is an example of devices that can communicate with each other over an exchange system and via a network according to some aspects.

FIG. 3 is a block diagram of a model of an example of a communications protocol system according to some aspects.

FIG. 4 is a hierarchical diagram of an example of a communications grid computing system including a variety of control and worker nodes according to some aspects.

FIG. 5 is a flow chart of an example of a process for determining edit operations for normalizing electronic communications using a neural network according to some aspects.

FIG. 6 is a model of an example of a recurrent neural network according to some aspects.

FIG. 7 is a model of an example of a memory cell usable with a Long-Short Term Memory neural network according to some aspects.

FIG. 8 is a table of an example of a database mapping noncanonical terms to canonical terms according to some aspects.

FIG. 9 is a flow chart of an example of a process for providing a vector of characters as input to a neural network according to some aspects.

FIG. 10 is an example of the vector of characters of FIG. 9 according to some aspects.

FIG. 11 is a flow chart of an example of a process determining edit operations for transforming a noncanonical communication into a normalized version of the noncanonical communication according to some aspects.

FIG. 12 is an example of a vector of edit operations for transforming a noncanonical term into a canonical term according to some aspects.

FIG. 13 is a model of an example of a neural network for normalizing electronic communications according to some aspects.

In the appended figures, similar components or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of examples of the technology. But various examples can be practiced without these specific details. The figures and description are not intended to be restrictive.

The ensuing description provides examples only, and is not intended to limit the scope, applicability, or configuration of the disclosure. Rather, the ensuing description of the examples provides those skilled in the art with an enabling description for implementing an example. Various changes may be made in the function and arrangement of elements without departing from the spirit and scope of the technology as set forth in the appended claims.

Specific details are given in the following description to provide a thorough understanding of the examples. But the examples may be practiced without these specific details. For example, circuits, systems, networks, processes, and other components can be shown as components in block diagram form to prevent obscuring the examples in unnecessary detail. In other examples, well-known circuits, processes, algorithms, structures, and techniques may be shown without unnecessary detail in order to avoid obscuring the examples.

Also, individual examples can be described as a process that is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but can have additional operations not included in a figure. A process can correspond to a method, a function, a procedure, a subroutine, a subprogram, etc. When a process corresponds to a function, its termination can correspond to a return of the function to the calling function or the main function.

Systems depicted in some of the figures can be provided in various configurations. In some examples, the systems can be configured as a distributed system where one or more components of the system are distributed across one or more networks in a cloud computing system.

Certain aspects and features of the present disclosure relate to determining edit operations for normalizing electronic communications using a neural network. An electronic communication can include a communication from an electronic device, such as a computing device. The electronic communication can include one or more (textual) words that are in a noncanonical form. In some examples, a word can be in a noncanonical form if the word is misspelled according to an accepted and standardized spelling of the word or does not comport with one or more standardized grammatical rules. For example, “ur” can be a noncanonical form of the word “you're.” As another example, “you're” can be a noncanonical version of the word “your,” if the grammatical context calls for the word “your” rather than “you're.” A word that is in a noncanonical form can be referred to as a noncanonical word, and an electronic communication containing a noncanonical word can be referred to as a noncanonical communication. It can be challenging to analyze noncanonical words in an electronic communication, such as to perform textual analysis. It can be desirable to normalize noncanonical words into their canonical form, such as to simplify textual analysis.

A computing device can determine edit operations for normalizing a noncanonical word into a canonical form using a neural network (e.g., a recurrent neural network). For example, the noncanonical communication “I like ur tie” can include the noncanonical word “ur.” The computing device can transmit data associated with the noncanonical word “ur” to the neural network. In some examples, the data can include a representation of a prior word positioned before the noncanonical term in the noncanonical communication (e.g., “like”), a subsequent word positioned after the noncanonical term in the noncanonical communication (e.g., “tie”), or both. In some examples, the data can additionally or alternatively include a representation of a part of speech or other information associated with the prior word, noncanonical term, subsequent word, or any combination of these. The neural network can receive the data and determine one or more word-level edit operations for converting the noncanonical word “ur” into a canonical form (e.g., “your”). In some examples, a word-level edit operation can include deleting a character from, replacing a character in, or inserting a character into the noncanonical word to transform the noncanonical word into a canonical form. For example, the neural network can determine a vector of word-level edit operations, such as “[insert_y_insert_o, none, none],” for transforming the noncanonical word “ur” into the canonical form “your.” Thus, in some examples, the neural network can determine one or more word-level edit operations using context information (e.g., the surrounding words, the part of speech, or other information) associated with a noncanonical word.

It can be desirable to optimize the vector of word-level edit operations to have the fewest vector components possible. In some examples, the computing device can optimize the vector of word-level edit operations by removing the “none” components of the vector. For example, the vector “[insert_y_insert_o, none, none]” for transforming the noncanonical term “ur” into a canonical form “your” can be optimized to “[insert_y_insert_o].” As another example, if a noncanonical term is actually correct (e.g., if the vector is “[none, none, none]” for the word “yes”), the vector can be optimized by removing all the “none” components, resulting in an empty vector or another default output.

In some examples, determining edit operations for converting a noncanonical word into a canonical form can be more efficient than directly determining the canonical form itself. For example, there may be 600 or fewer possible combinations of edit operations for the neural network to select from to determine the correct word-level edit operation combination. Conversely, there may be 8,000 or more possible canonical words for the neural network to select from to directly determine the canonical form itself. The neural network can perform fewer operations to determine the edit operations, because the neural network can have fewer options to select from. This can improve computer efficiency and reduce processing costs.

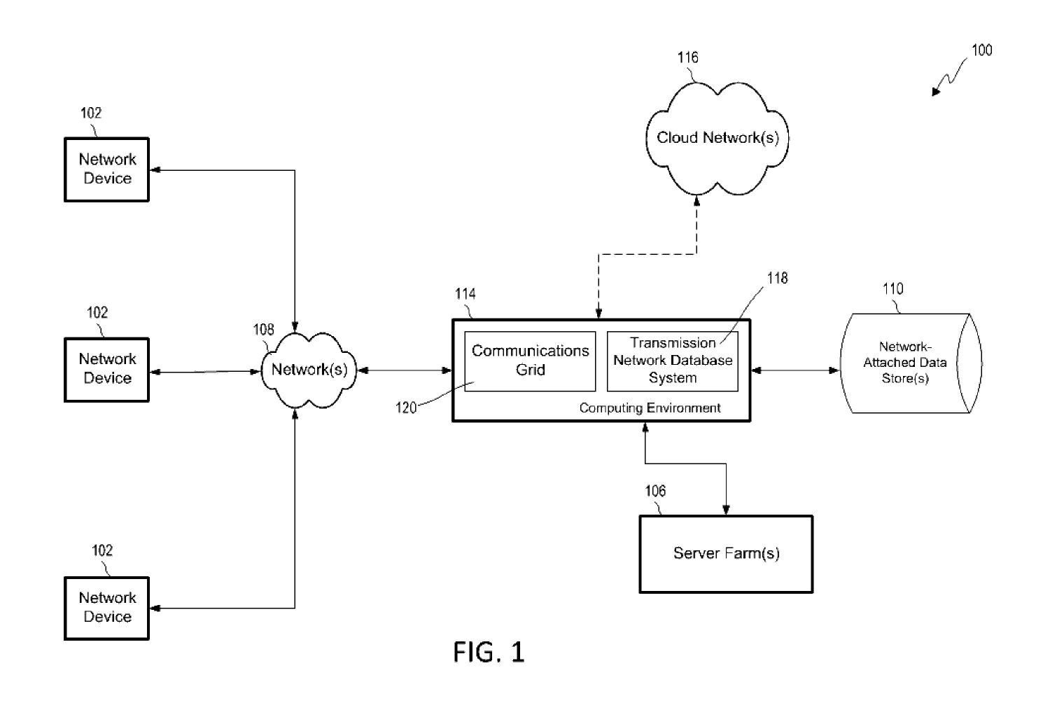

FIGS. 1-4 depict examples of systems usable for determining edit operations for normalizing electronic communications using a neural network. For example, FIG. 1 is a block diagram of an example of the hardware components of a computing system according to some aspects. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. The computing environment 114 may include one or more other systems. For example, computing environment 114 may include a database system 118 or a communications grid 120.

Data transmission network 100 also includes one or more network devices 102. Network devices 102 may include client devices that can communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108.

In some examples, network devices 102 may provide a large amount of data, either all at once or streaming over a period of time (e.g., using event stream processing (ESP)), to the computing environment 114 via networks 108. For example, the network devices can transmit electronic communications with noncanonical words, either all at once or streaming over a period of time, to the computing environment 114 via networks 108.

The network devices 102 may include network computers, sensors, databases, or other devices that may transmit or otherwise provide data to computing environment 114. For example, network devices 102 may include local area network devices, such as routers, hubs, switches, or other computer networking devices. These devices may provide a variety of stored or generated data, such as network data or data specific to the network devices 102 themselves. Network devices 102 may also include sensors that monitor their environment or other devices to collect data regarding that environment or those devices, and such network devices 102 may provide data they collect over time. Network devices 102 may also include devices within the internet of things, such as devices within a home automation network. Some of these devices may be referred to as edge devices, and may involve edge-computing circuitry. Data may be transmitted by network devices 102 directly to computing environment 114 or to network-attached data stores, such as network-attached data stores 110 for storage so that the data may be retrieved later by the computing environment 114 or other portions of data transmission network 100. For example, the network devices 102 can transmit data with noncanonical information to a network-attached data store 110 for storage. The computing environment 114 may later retrieve the data from the network-attached data store 110 and use the data for textual analysis.

Network-attached data stores 110 can store data to be processed by the computing environment 114 as well as any intermediate or final data generated by the computing system in non-volatile memory. But in certain examples, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated dynamically (e.g., on the fly). In this situation, the computing environment 114 may be configured to retain the processed information within memory so that responses can be generated for the user at different levels of detail as well as allow a user to interactively query against this information.

Network-attached data stores 110 may store a variety of different types of data organized in a variety of different ways and from a variety of different sources. For example, network-attached data stores may include storage other than primary storage located within computing environment 114 that is directly accessible by processors located therein. Network-attached data stores may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as compact disk or digital versatile disk, flash memory, memory or memory devices. A computer-program product may include code or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as data from a website (e.g., a forum post, a Twitter™ tweet, a Facebook™ post, a blog post, an online review), a text message, an e-mail, or any combination of these.

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time-stamped data may be aggregated by time (e.g., into daily time period units) to generate time series data or structured hierarchically according to one or more dimensions (e.g., parameters, attributes, or variables). For example, data may be stored in a hierarchical data structure, such as a relational online analytical processing (ROLAP) or multidimensional online analytical processing (MOLAP) database, or may be stored in another tabular form, such as in a flat-hierarchy form.

Data transmission network 100 may also include one or more server farms 106. Computing environment 114 may route select communications or data to the sever farms 106 or one or more servers within the server farms 106. Server farms 106 can be configured to provide information in a predetermined manner. For example, server farms 106 may access data to transmit in response to a communication. Server farms 106 may be separately housed from each other device within data transmission network 100, such as computing environment 114, or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more websites, sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time. As another example, website data may be analyzed to determine one or more trends in comments, posts, or other data provided by users.

Data transmission network 100 may also include one or more cloud networks 116. Cloud network 116 may include a cloud infrastructure system that provides cloud services. In certain examples, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network 116 can dynamically scale to meet the needs of its users. The cloud network 116 may include one or more computers, servers, or systems. In some examples, the computers, servers, or systems that make up the cloud network 116 are different from the user's own on-premises computers, servers, or systems. For example, the cloud network 116 may host an application, and a user may, via a communication network such as the Internet, order and use the application on demand. In some examples, the cloud network 116 may host an application for performing data analytics or textual analysis on data that includes noncanonical information.

While each device, server, and system in FIG. 1 is shown as a single device, multiple devices may instead be used. For example, a set of network devices can be used to transmit various communications from a single user, or remote server 140 may include a server stack. As another example, data may be processed as part of computing environment 114.

Each communication within data transmission network 100 (e.g., between client devices, between a device and connection management system 150, between server farms 106 and computing environment 114, or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired or wireless networks may be implemented using routers, access points, bridges, gateways, or the like, to connect devices in the network 108. The networks 108 can be incorporated entirely within or can include an intranet, an extranet, or a combination thereof. In one example, communications between two or more systems or devices can be achieved by a secure communications protocol, such as secure sockets layer (SSL) or transport layer security (TLS). In addition, data or transactional details may be encrypted.

Some aspects may utilize the Internet of Things (IoT), where things (e.g., machines, devices, phones, sensors) can be connected to networks and the data from these things can be collected and processed within the things or external to the things. For example, the IoT can include sensors in many different devices, and high value analytics can be applied to identify hidden relationships and drive increased efficiencies. This can apply to both big data analytics and real-time (e.g., ESP) analytics.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The computing nodes in the communications grid 120 and the transmission network database system 118 may share the same processor hardware, such as processors that are located within computing environment 114.

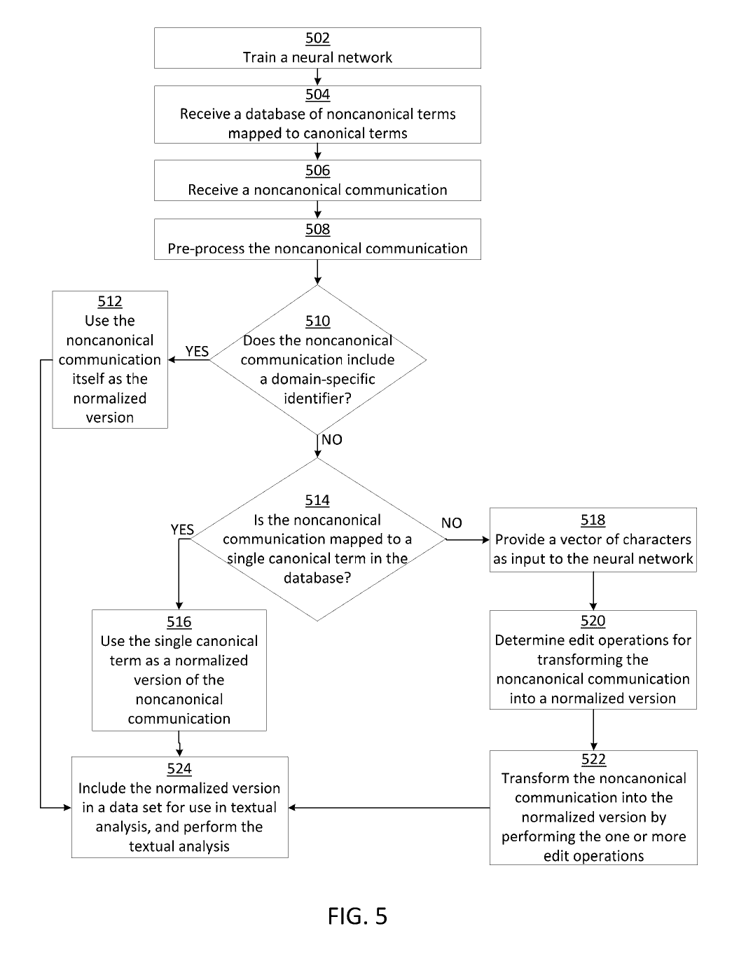

In some examples, the computing environment 114, a network device 102, or both can implement one or more processes for determining edit operations for normalizing electronic communications using a neural network. For example, the computing environment 114, a network device 102, or both can implement one or more versions of the processes discussed with respect to FIGS. 5, 9, and 11.

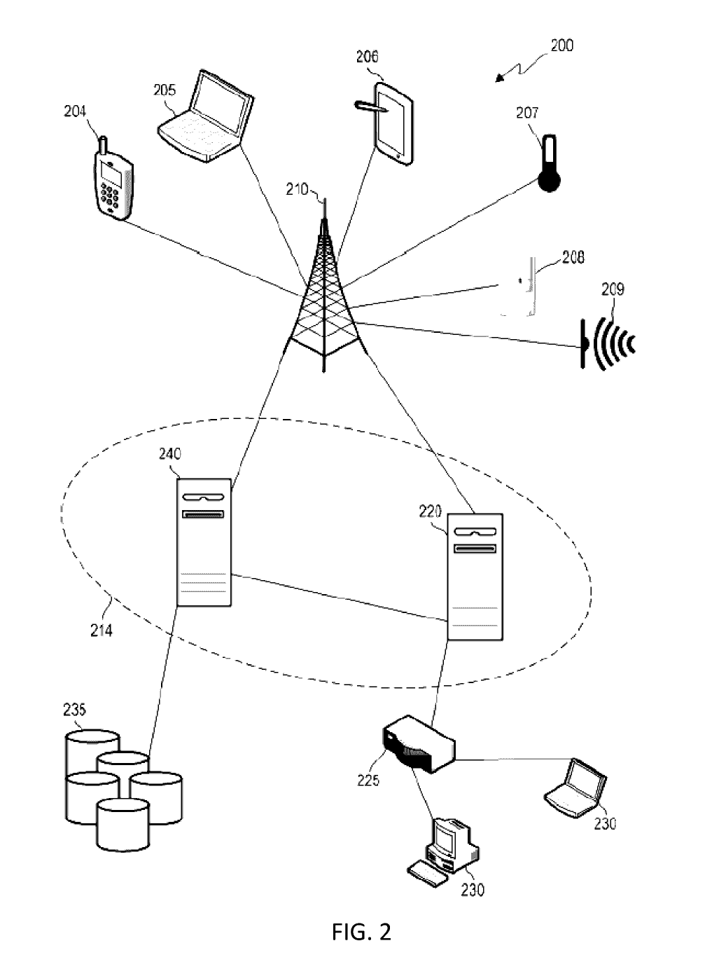

FIG. 2 is an example of devices that can communicate with each other over an exchange system and via a network according to some aspects. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). In some examples, the communication can include noncanonical information. The communication can be routed to another network device, such as network devices 205-209, via base station 210. The communication can also be routed to computing environment 214 via base station 210. In some examples, the network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems. The network devices may detect and record data related to the environment that it monitors, and transmit that data to computing environment 214.

The network devices 204-209 may also perform processing on data it collects before transmitting the data to the computing environment 214, or before deciding whether to transmit data to the computing environment 214. For example, network devices 204-209 may determine whether data collected meets certain rules, for example by comparing data or values calculated from the data and comparing that data to one or more thresholds. The network devices 204-209 may use this data or comparisons to determine if the data is to be transmitted to the computing environment 214 for further use or processing. In some examples, the network devices 204-209 can pre-process the data prior to transmitting the data to the computing environment 214. For example, the network devices 204-209 can transform data that includes noncanonical information into a canonical form before transmitting the data to the computing environment 214 for further processing (e.g., which can include applying big data analytics or textual analysis to the data).

Computing environment 214 may include machines 220, 240. Although computing environment 214 is shown in FIG. 2 as having two machines 220, 240, computing environment 214 may have only one machine or may have more than two machines. The machines 220, 240 that make up computing environment 214 may include specialized computers, servers, or other machines that are configured to individually or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with client devices 230 via one or more routers 225. Computing environment 214 may collect, analyze or store data from or pertaining to communications, client device operations, client rules, or user-associated actions stored at one or more data stores 235. Such data may influence communication routing to the devices within computing environment 214, how data is stored or processed within computing environment 214, among other actions.

Notably, various other devices can further be used to influence communication routing or processing between devices within computing environment 214 and with devices outside of computing environment 214. For example, as shown in FIG. 2, computing environment 214 may include a machine 240 that is a web server. Computing environment 214 can retrieve data of interest, such as client information (e.g., product information, client rules, etc.), technical product details, news, blog posts, e-mails, forum posts, electronic documents, social media posts (e.g., Twitter™ posts or Facebook™ posts), and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices 204-209 may receive data periodically and in real time from a web server or other source. Devices within computing environment 214 may also perform pre-analysis on data it receives to determine if the data received should be processed as part of an ongoing project. For example, as part of a project in which textual analysis is performed on one or more electronic communications, the computing environment 214 can perform pre-analysis of the one or more electronic communications. The pre-analysis can include normalizing the electronic communications by converting one or more noncanonical words in an electronic communication into a canonical version of the noncanonical word. The computing environment 214 can determine the canonical version of the noncanonical word at least in part by determining edit operations using one or more neural networks.

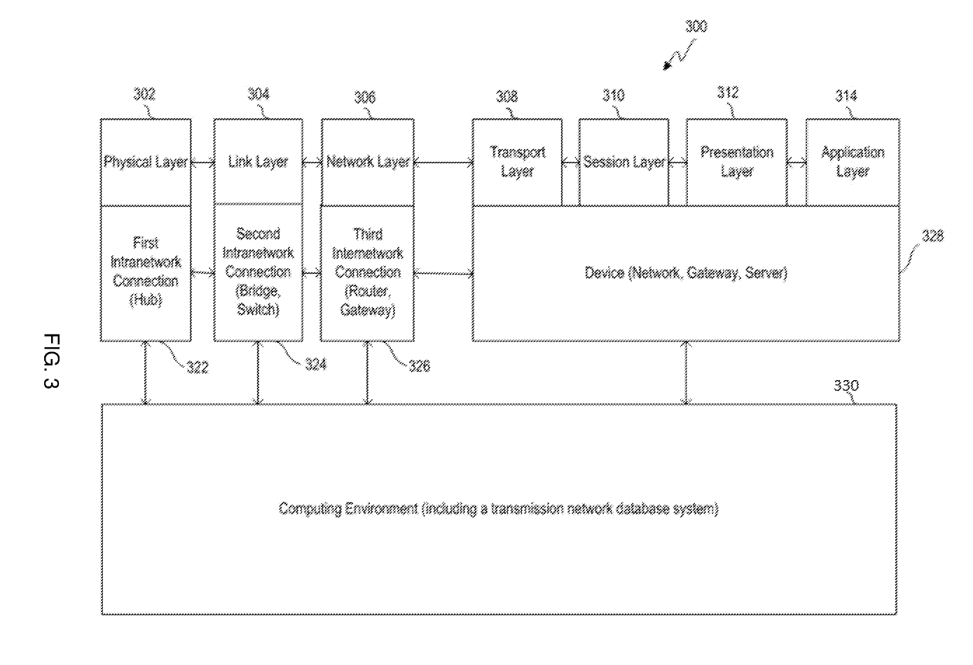

FIG. 3 is a block diagram of a model of an example of a communications protocol system according to some aspects. More specifically, FIG. 3 identifies operation of a computing environment in an Open Systems Interaction model that corresponds to various connection components. The model 300 shows, for example, how a computing environment, such as computing environment (or computing environment 214 in FIG. 2) may communicate with other devices in its network, and control how communications between the computing environment and other devices are executed and under what conditions.

The model 300 can include layers 302-314. The layers 302-314 are arranged in a stack. Each layer in the stack serves the layer one level higher than it (except for the application layer, which is the highest layer), and is served by the layer one level below it (except for the physical layer 302, which is the lowest layer). The physical layer 302 is the lowest layer because it receives and transmits raw bites of data, and is the farthest layer from the user in a communications system. On the other hand, the application layer is the highest layer because it interacts directly with a software application.

As noted, the model 300 includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (e.g., move) data across a network. The link layer manages node-to-node communications, such as within a grid-computing environment. Link layer 304 can detect and correct errors (e.g., transmission errors in the physical layer 302). Link layer 304 can also include a media access control (MAC) layer and logical link control (LLC) layer.

Network layer 306 can define the protocol for routing within a network. In other words, the network layer coordinates transferring data across nodes in a same network (e.g., such as a grid-computing environment). Network layer 306 can also define the processes used to structure local addressing within the network.

Transport layer 308 can manage the transmission of data and the quality of the transmission or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt or format data based on data types known to be accepted by an application or network layer.

Application layer 314 interacts directly with software applications and end users, and manages communications between them. Application layer 314 can identify destinations, local resource states or availability or communication content or formatting using the applications.

For example, a communication link can be established between two devices on a network. One device can transmit an analog or digital representation of an electronic message that includes noncanonical information to the other device. The other device can receive the analog or digital representation at the physical layer 302. The other device can transmit the data associated with the electronic message through the remaining layers 304-314. The application layer 314 can receive data associated with the electronic message. The application layer 314 can identify one or more applications, such as a textual analysis application, to which to transmit data associated with the electronic message. The application layer 314 can transmit the data to the identified application.

Intra-network connection components 322, 324 can operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-314. For example, routers can operate in the network layer and network devices can operate in the transport, session, presentation, and application layers.

A computing environment 330 can interact with or operate on, in various examples, one, more, all or any of the various layers. For example, computing environment 330 can interact with a hub (e.g., via the link layer) to adjust which devices the hub communicates with. The physical layer 302 may be served by the link layer 304, so it may implement such data from the link layer 304. For example, the computing environment 330 may control devices from which it can receive data from. For example, if the computing environment 330 knows that a certain network device has turned off, broken, or otherwise become unavailable or unreliable, the computing environment 330 may instruct the hub to prevent any data from being transmitted to the computing environment 330 from that network device. Such a process may be beneficial to avoid receiving data that is inaccurate or that has been influenced by an uncontrolled environment. As another example, computing environment 330 can communicate with a bridge, switch, router or gateway and influence which device within the system (e.g., system 200) the component selects as a destination. In some examples, computing environment 330 can interact with various layers by exchanging communications with equipment operating on a particular layer by routing or modifying existing communications. In another example, such as in a grid-computing environment, a node may determine how data within the environment should be routed (e.g., which node should receive certain data) based on certain parameters or information provided by other layers within the model.

The computing environment 330 may be a part of a communications grid environment, the communications of which may be implemented as shown in the protocol of FIG. 3. For example, referring back to FIG. 2, one or more of machines 220 and 240 may be part of a communications grid-computing environment. A gridded computing environment may be employed in a distributed system with non-interactive workloads where data resides in memory on the machines, or compute nodes. In such an environment, analytic code, instead of a database management system, can control the processing performed by the nodes. Data is co-located by pre-distributing it to the grid nodes, and the analytic code on each node loads the local data into memory. Each node may be assigned a particular task, such as a portion of a processing project, or to organize or control other nodes within the grid. For example, each node may be assigned a portion of a processing task for determining edit operations for normalizing electronic communications using one or more neural networks.

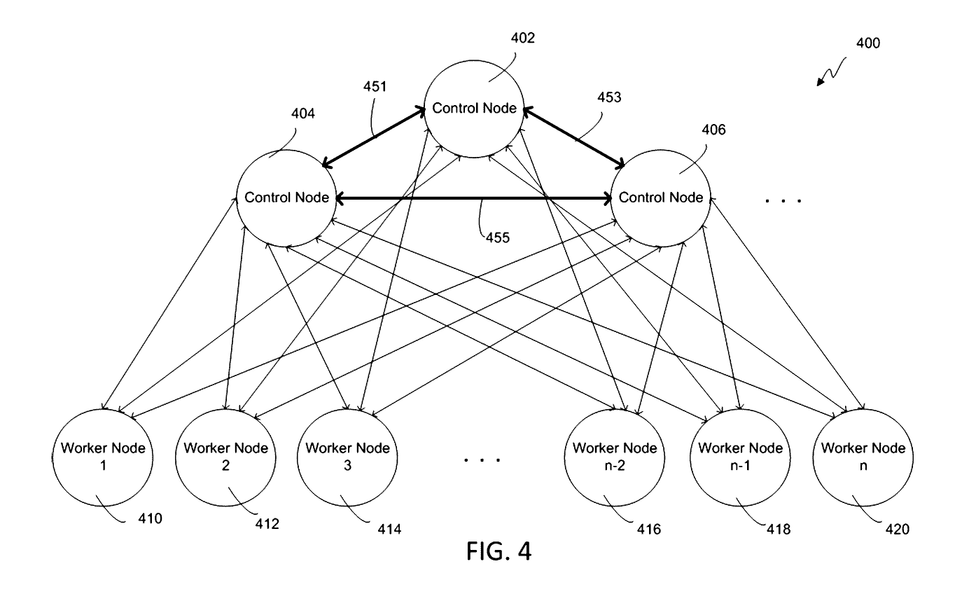

FIG. 4 is a hierarchical diagram of an example of a communications grid computing system 400 including a variety of control and worker nodes according to some aspects. Communications grid computing system 400 includes three control nodes and one or more worker nodes. Communications grid computing system 400 includes control nodes 402, 404, and 406. The control nodes 402-406 are communicatively connected via communication paths 451, 453, and 455. The control nodes may transmit information (e.g., related to the communications grid or notifications) to and receive information from each other. Although communications grid computing system 400 is shown in FIG. 4 as including three control nodes, the communications grid may include more or less than three control nodes.

Communications grid computing system 400 (which can be referred to as a “communications grid”) also includes one or more worker nodes. Shown in FIG. 4 are six worker nodes 410-420. Although FIG. 4 shows six worker nodes, a communications grid can include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid computing system 400 may be connected (wired or wirelessly, and directly or indirectly) to control nodes 402-406. Each worker node may receive information from the control nodes (e.g., an instruction to perform work on a project) and may transmit information to the control nodes (e.g., a result from work performed on a project). Furthermore, worker nodes may communicate with each other directly or indirectly. For example, worker nodes may transmit data between each other related to a textual analysis job being performed or an individual task within a textual analysis job being performed by that worker node. In some examples, worker nodes may not be connected (communicatively or otherwise) to certain other worker nodes. For example, a worker node 410 may only be able to communicate with a particular control node 404. The worker node 410 may be unable to communicate with other worker nodes 412-420 in the communications grid, even if the other worker nodes 412-420 are controlled by the same control node 404.

A control node 402-406 may connect with an external device with which the control node 402-406 may communicate (e.g., a communications grid user, such as a server or computer, may connect to a controller of the grid). For example, a server or computer may connect to control nodes 402-406 and may transmit a project or job to the node, such as a textual analysis project or a normalization project for transforming a noncanonical communication into a canonical form. The project may include a data set. The data set may be of any size. Once the control node 402-406 receives such a project including a large data set, the control node may distribute the data set or projects related to the data set to be performed by worker nodes. Alternatively, for a project including a large data set, the data set may be receive or stored by a machine other than a control node 402-406 (e.g., a Hadoop data node).

Control nodes 402-406 can maintain knowledge of the status of the nodes in the grid (e.g., grid status information), accept work requests from clients, subdivide the work across worker nodes, and coordinate the worker nodes, among other responsibilities. Worker nodes 412-420 may accept work requests from a control node 402-406 and provide the control node with results of the work performed by the worker node. A grid may be started from a single node (e.g., a machine, computer, server, etc.). This first node may be assigned or may start as the primary control node 402 that will control any additional nodes that enter the grid.

When a project is submitted for execution (e.g., by a client or a controller of the grid) it may be assigned to a set of nodes. After the nodes are assigned to a project, a data structure (e.g., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node 402 receives a project, the primary control node may distribute portions of the project to its worker nodes for execution. For example, a project for determining edit operations for normalizing an electronic communication using a neural network can be initiated on communications grid computing system 400. A primary control node can control the work to be performed for the project in order to complete the project as requested or instructed. The primary control node may distribute work to the worker nodes 412-420 based on various factors, such as which subsets or portions of projects may be completed most efficiently and in the correct amount of time. For example, a worker node 410 may perform analysis or normalization on a portion of data that is already local (e.g., stored on) the worker node. The primary control node also coordinates and processes the results of the work performed by each worker node 412-420 after each worker node 412-420 executes and completes its job. For example, the primary control node may receive a result from one or more worker nodes 412-420, and the primary control node may organize (e.g., collect and assemble) the results received and compile them to produce a complete result for the project received from the end user.

Any remaining control nodes, such as control nodes 404, 406, may be assigned as backup control nodes for the project. In an example, backup control nodes may not control any portion of the project. Instead, backup control nodes may serve as a backup for the primary control node and take over as primary control node if the primary control node were to fail. If a communications grid were to include only a single control node 402, and the control node 402 were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes 402-406, including a backup control node, may be beneficial.

In some examples, the primary control node may open a pair of listening sockets to add another node or machine to the grid. A socket may be used to accept work requests from clients, and the second socket may be used to accept connections from other grid nodes. The primary control node may be provided with a list of other nodes (e.g., other machines, computers, servers, etc.) that can participate in the grid, and the role that each node can fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it can check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. But, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404, 406 (and, for example, to other control or worker nodes 410, 412 within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes 410-420 in the communications grid, unique identifiers of the worker nodes 410-420, or their relationships with the primary control node 402) and the status of a project (including, for example, the status of each worker node's portion of the project). The snapshot may also include analysis or results received from worker nodes 410-420 in the communications grid. The backup control nodes 404, 406 may receive and store the backup data received from the primary control node 402. The backup control nodes 404, 406 may transmit a request for such a snapshot (or other information) from the primary control node 402, or the primary control node 402 may send such information periodically to the backup control nodes 404, 406.

As noted, the backup data may allow a backup control node 404, 406 to take over as primary control node if the primary control node 402 fails without requiring the communications grid to start the project over from scratch. If the primary control node 402 fails, the backup control node 404, 406 that will take over as primary control node may retrieve the most recent version of the snapshot received from the primary control node 402 and use the snapshot to continue the project from the stage of the project indicated by the backup data. This may prevent failure of the project as a whole.

A backup control node 404, 406 may use various methods to determine that the primary control node 402 has failed. In one example of such a method, the primary control node 402 may transmit (e.g., periodically) a communication to the backup control node 404, 406 that indicates that the primary control node 402 is working and has not failed, such as a heartbeat communication. The backup control node 404, 406 may determine that the primary control node 402 has failed if the backup control node has not received a heartbeat communication for a certain predetermined period of time. Alternatively, a backup control node 404, 406 may also receive a communication from the primary control node 402 itself (before it failed) or from a worker node 410-420 that the primary control node 402 has failed, for example because the primary control node 402 has failed to communicate with the worker node 410-420.

Different methods may be performed to determine which backup control node of a set of backup control nodes (e.g., backup control nodes 404, 406) can take over for failed primary control node 402 and become the new primary control node. For example, the new primary control node may be chosen based on a ranking or “hierarchy” of backup control nodes based on their unique identifiers. In an alternative example, a backup control node may be assigned to be the new primary control node by another device in the communications grid or from an external device (e.g., a system infrastructure or an end user, such as a server or computer, controlling the communications grid). In another alternative example, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative example, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed. In some examples, edit operations for normalizing electronic communications can be determined using such a communications grid computing system 400.

FIG. 5 is a flow chart of an example of a process for determining edit operations for normalizing electronic communications using a neural network according to some aspects. Some examples can be implemented using any of the systems and configurations described with respect to FIGS. 1-4.

In block 502, a processor trains a neural network. The neural network can include one or more computer-implemented algorithms or models. Typically, neural networks can be represented as one or more layers of interconnected “neurons” that can exchange data between one another. The connections between the neurons can have numeric weights that can be tuned based on experience. Such tuning can make neural networks adaptive and capable of “learning.” Tuning the numeric weights can increase the accuracy of output provided by the neural network.

The numeric weights can be tuned through a process referred to as training. In some examples, the processor can train the neural network using training data. The processor can provide the training data to the neural network, and the neural network can use the training data to tune one or more numeric weights of the neural network. In some examples, the neural network can be trained using backpropagation. Backpropagation can include determining a gradient of a particular numeric weight based on a difference between an actual output of the neural network and a desired output of the neural network. Based on the gradient, one or more numeric weights of the neural network can be updated to reduce the difference, thereby increasing the accuracy of the neural network. This process can be repeated multiple times to train the neural network.

In some examples, the neural network includes a deep neural network. A deep neural network can include a neural network having one or more hidden layers of units (“neurons”) between an input layer and an output layer of the neural network. Such layers between the input layer and the output layer may be referred to as “hidden” because they may not be directly observable in the normal functioning of the neural network. A deep neural network can include any number of hidden layers, and each hidden layer can include any number of neurons.

In some examples, the neural network can include a recurrent neural network (RNN). A RNN can be a type of deep neural network. The RNN can include an input layer, at least one hidden layer, and an output layer. In some examples, the RNN can include connections between neurons of the input layer and one or more neurons of the hidden layer. These connections can be referred to as input-to-hidden connections. Each input-to-hidden connection can receive input data, transform the input data into a new state, and transmit the transformed input data to the hidden layer. In some examples, the RNN can include one or more connections between neurons of the hidden layer. These connections can be referred to as hidden-to-hidden connections. Each hidden-to-hidden connection can transform a state of the hidden layer at a previous time step (e.g., t₋₁) into a new state and transmit the new state back to the hidden layer at the current time step (e.g., t₀). In some examples, the RNN can include connections between neurons of the hidden layer and one or more neurons of the output layer. These connections can be referred to as hidden-to-output connections. Each hidden-to-output connection can transform a state of the hidden layer into a new state and transmit the new state to the output layer.

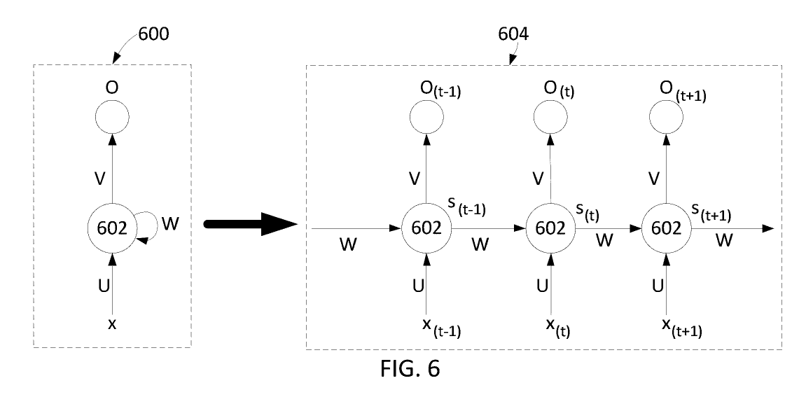

An example of a RNN is shown in FIG. 6. The RNN 600 can include a weight matrix U for an input-to-hidden connection, a weight matrix W for a hidden-to-hidden (e.g., recurrent) connection, and a weight matrix V for a hidden-to-output connection. For each time step over a period of time, the RNN 600 can receive an input x, transform the input x using weight matrix U, and provide the transformed input to the hidden node 602. The transformed input, in conjunction with a transformed previous hidden state using a weight matrix W, can induce a current state in the hidden node 602. The hidden node 602 can provide an output based on the state of the hidden node 602, which can be multiplied by weight matrix V to produce a transformed output O.

A representation of the above-described process, occurring over three time steps, is shown in box 604. For example, moving from left to right within box 604, at time t−1, the RNN 600 receives an input x₍ₜ₋₁₎, which induces a state s₍ₜ₋₁₎, in hidden node 602, which causes an output O₍ₜ₋₁₎. At time t, the RNN 600 receives an input x₍ₜ₎, which induces a state s₍ₜ₎ in hidden node 602, which causes an output O₍ₜ₎. At time t+1, the RNN 600 receives an input x₍ₜ₊₁₎, which induces a state s₍ₜ₊₁₎, in hidden node 602, which causes an output O₍ₜ₊₁₎.

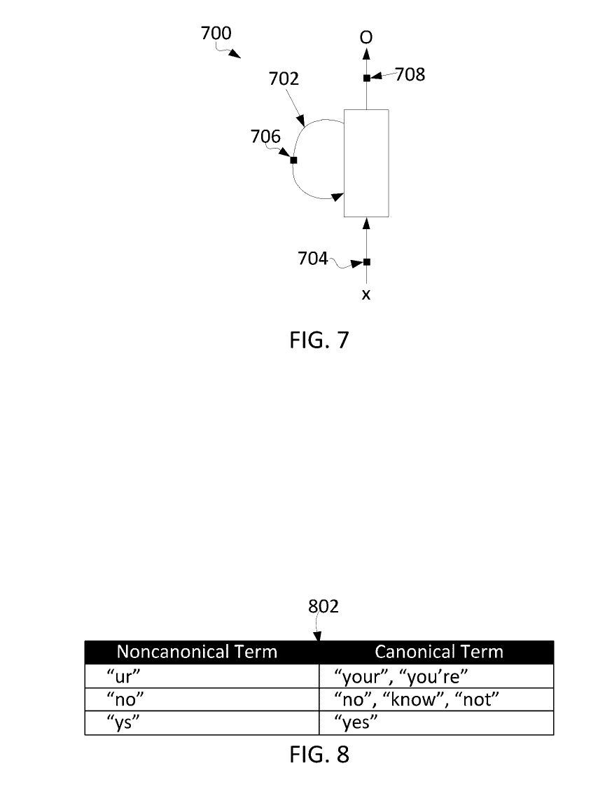

In some examples, the neural network can include a long-short term memory (LSTM) neural network. The LSTM neural network can be a type of RNN. In some examples, the LSTM can include one or more memory cells. For example, the LSTM can replace the hidden node 602 of FIG. 6 with a memory cell, such as the memory cell 700 shown in FIG. 7. Referring to FIG. 7, the memory cell 700 can include a self-recurrent connection 702, an input gate 704, a forget gate 706, an output gate 708, or any combination of these. The input gate 704 can modulate incoming signals to the memory cell 700. The output gate 708 can modulate outgoing signals from the memory cell 700. The forget gate 706 can control whether the memory cell 700 remembers or forgets a previous state of the memory cell 700. For example, the forget gate 706 can control whether the memory cell 700 should save the previous state of the memory cell 700 for a period of time or forget the previous state of the memory cell 700. In some examples, the memory cell 700 can allow a LSTM to have a longer “memory” than other kinds of neural networks, such as a traditional RNN.

Referring back to FIG. 5, in block 504, the processor receives a database of noncanonical terms mapped to canonical terms. In some examples, the processor can receive the database from a remote server or computing device. For example, the processor can download the database from the remote server. In other examples, a user can input at least a portion of the database. For example, the processor can receive user input indicating a mapping between a noncanonical term and one or more corresponding canonical terms.

An example of the database is shown in FIG. 8. The database 802 can include a list of noncanonical terms, such as “ur,” “no,” and “ys.” Each noncanonical term can be mapped to one or more corresponding canonical terms. For example, “ur” can be mapped to “your” and “you're” in the database 802. As another example, “no” can be mapped to “no,” “know,” and “not” in the database 802.

In some examples, the processor can generate the database by analyzing a data set, such as a pre-labeled data set or training data used for training a neural network (e.g., the neural network of block 502). The processor can access the data set and determine a noncanonical term within the data set. The processor can then determine one or more canonical terms within the data set that correspond to the noncanonical term. The processor can map the noncanonical term to the one or more canonical terms in the database. The processor can repeat this process for multiple noncanonical terms in the data set to construct the database.

In block 506 of FIG. 5, the processor receives a noncanonical communication. The noncanonical communication can include one or more words that are in a noncanonical form. As discussed above, a word can be in a noncanonical form if the word is misspelled according to an accepted and standardized spelling of the word; does not comport with one or more standardized grammatical rules; or both. A shorthand version of a word, a misspelled version of the word, or a grammatically incorrect version of the word can be examples of noncanonical forms of the word.

The processor can receive the noncanonical communication in an electronic form. For example, the processor can receive an electronic representation of the noncanonical communication over a network. In some examples, the noncanonical communication can include data from a forum post, a text message, an e-mail, a social media post (e.g., a Twitter™ tweet or a Facebook™ post), a blog post, an online review, an electronic document, or any combination of these.

In block 508, the processor pre-processes the noncanonical communication. For example, the processor can transform one or more characters in the noncanonical communication from an uppercase format to a lowercase format. As another example, the processor can transform one or more characters in the noncanonical communication from a lowercase format to an uppercase format.

In block 510, the processor determines if the noncanonical communication includes a domain-specific identifier. The domain-specific identifier can include one or more characters that can indicate a special meaning or purpose associated with the noncanonical communication. For example, the domain-specific identifier “http://” can indicate that the noncanonical communication is a hyperlink. Other examples of domain-specific identifiers can include “#” and “@”. For example, the processor can determine that the noncanonical communication “#SASrules” includes the domain-specific identifier “#.” In some examples, the domain-specific identifier can suggest that characters following the domain-specific identifier are intended to be in their particular format or configuration.

If the processor determines that the noncanonical communication includes a domain-specific character, the process can proceed to block 512. Otherwise, the process can proceed to block 514.

In block 512, the processor uses the noncanonical communication itself as the normalized version of the noncanonical communication. As discussed above, the inclusion of a domain-specific character in the noncanonical communication can suggest that the characters following the domain-specific are intended to be in their particular format and should not be changed (or normalized). Thus, the processor can use the noncanonical communication itself as the normalized version of the noncanonical communication.

In block 514, the processor determines if the noncanonical communication is mapped to a single canonical term in the database. In some examples, the processor can access the database and determine if a noncanonical term (of the noncanonical communication) is mapped to one, or more than one, corresponding canonical term. For example, referring to FIG. 8, the processor can access the database 802 and map the noncanonical term “ys” to the single canonical term “yes.” In another example, the processor can access the database 802 and map the noncanonical term “ur” to the two canonical terms “your” and “you're.”

In some examples, a noncanonical communication can include adjacent repeated characters. For example, the noncanonical communication “soooo” can include the repeated characters “oooo.” The adjacent repeated characters may be included in the noncanonical communication for emphasis. In some examples, the processor can replace the adjacent repeated characters with a single character. For example, the processor can replace “oooo” in the noncanonical communication “soooo” with “o,” resulting in the transformed noncanonical communication “so.” The processor can additionally or alternatively determine if the transformed noncanonical communication is mapped to one or more canonical terms in the database.

In some examples, the processor can additionally or alternatively replace the adjacent repeated characters with two characters. For example, the processor can replace “oooo” in the noncanonical communication “looook” with “oo,” resulting in the transformed noncanonical communication “look.” The processor can additionally or alternatively determine if the transformed noncanonical communication is mapped to one or more canonical terms in the database.

If the processor determines that the noncanonical communication (or a transformed noncanonical communication) is mapped to one canonical term in the database, the process can continue to block 516. Otherwise, the process can continue to block 518.

In block 516, the processor uses the single canonical term in the database as the normalized version of the noncanonical communication. For example, the processor can access the database and map the noncanonical term “ys” to the single canonical term “yes.” The processor can use the single canonical term “yes” as the normalized version of the noncanonical communication. In some examples, the processor can use the single canonical term in the database as the normalized version of the noncanonical communication because there are no other canonical options available to select from.

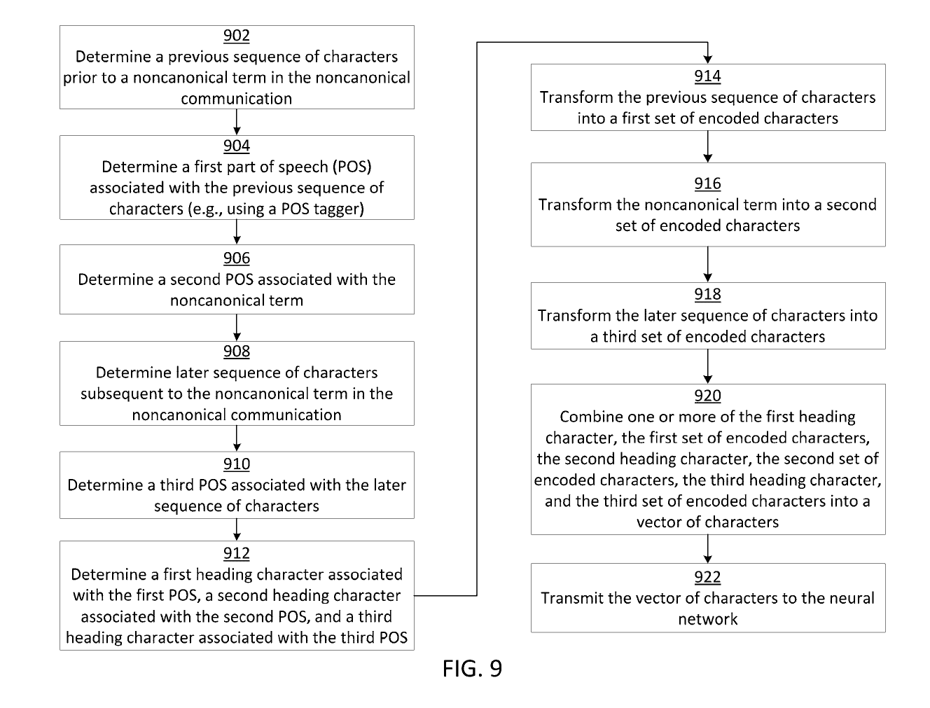

In block 518, the processor provides a vector of characters as input to the neural network. The vector of characters can be associated with the noncanonical communication. In some examples, the processor can determine the vector of characters, and provide the vector of characters to the neural network, according to one or more of the steps shown in FIG. 9.

In block 902, the processor determines a previous sequence of characters that are prior to a noncanonical term in the noncanonical communication. For example, if the noncanonical communication is “I think ur nice,” the previous sequence of characters can include “I think” or just “think.” In some examples, the processor can locate the noncanonical term within a string of characters included within the noncanonical communication. The processor can then select a predetermined number of characters prior to the noncanonical term as the previous sequence of characters. The predetermined number of characters can include one or more words.

In some examples, the previous sequence of characters can include one or more padding characters. For example, if the noncanonical communication is “ur nice,” the noncanonical term “ur” is at the beginning of the noncanonical communication, and there are no characters prior to the noncanonical term “ur” in the noncanonical communication. In such an example, the processor can use a predetermined number of padding characters as the previous sequence of characters. In some examples, the padding character can include a space, an underscore, a special character, etc.

In block 904, the processor determines a first part of speech (POS) associated with a previous sequence of characters. In some examples, the processor can use a POS tagger to determine the first POS. The POS tagger can include one or more algorithms or neural networks (e.g., separate from the neural network of block 502 in FIG. 5) configured to receive an input word and determine a part of speech for the input word. The processor can provide the previous sequence of characters to the POS tagger and receive a corresponding part of speech from the POS tagger. For example, for the noncanonical communication “I think ur nice,” the processor can provide the word “think” to the POS tagger and receive a corresponding part of speech for the word “think.”

In some examples, if the previous sequence of characters includes a padding character, the POS tagger can output a default result. For example, if the previous sequence of characters includes one or more padding characters, the POS tagger can output “none,” “0,” “false,” or a default part of speech.

In block 906, the processor determines a second POS associated with the noncanonical term. The processor can provide the noncanonical term to the POS tagger and receive a corresponding part of speech from the POS tagger. For example, for the noncanonical communication “I think ur nice,” the processor can provide the noncanonical term “ur” to the POS tagger and receive a corresponding part of speech for the noncanonical term “ur.”

In block 908, the processor determines a later sequence of characters that are subsequent to the noncanonical term in the noncanonical communication. For example, if the noncanonical communication is “I think ur nice,” the later sequence of characters can include “nice.” In some examples, the processor can locate the noncanonical term within a string of characters included within the noncanonical communication. The processor can then select a predetermined number of characters subsequent to the noncanonical term as the later sequence of characters. The predetermined number of characters can include one or more words.

In some examples, the later sequence of characters can include one or more padding characters. For example, if the noncanonical communication is “she asked me your address and I said I didn't no,” the noncanonical term “no” is at the end of the noncanonical communication, and there are no characters after the noncanonical term “no” in the noncanonical communication. In such an example, the processor can use a predetermined number of padding characters as the later sequence of characters.

In block 910, the processor determines a third part of speech associated with the later sequence of characters. The processor can provide the later sequence of characters to the POS tagger and receive a corresponding part of speech from the POS tagger. For example, for the noncanonical communication “I think ur nice,” the processor can provide the word “nice” to the POS tagger and receive a corresponding part of speech for the word “nice.”

In some examples, if the later sequence of characters includes a padding character, the POS tagger can output a default result. For example, if the previous sequence of characters includes one or more padding characters, the POS tagger can output “none,” “0,” “false,” or a default part of speech.

In block 912, the processor determines a first heading character associated with the first POS, a second heading character associated with the second POS, and a third heading character associated with the third POS. A heading character can include a number, a vector of numbers, one or more characters, etc.

In some examples, the processor can use a database to determine the first heading character, the second heading character, the third heading character, or any combination of these. The database can include multiple parts of speech (e.g., noun, verb, adverb, and adjective), with each part of speech mapped to a particular heading character. For example, the number 1 can be mapped to “noun,” the number 2 can be mapped to “verb,” the number 3 can be mapped to “adverb,” and the number 4 can be mapped to “adjective.” The processor can access the database and determine heading characters corresponding to the first part of speech, the second part of speech, and the third part of speech. In other examples, the processor can use an algorithm or a neural network to determine the first heading character, the second heading character, the third heading character, or any combination of these.

In block 914, the processor transforms the previous sequence of characters into a first set of encoded characters. For example, the processor can map each character in the previous sequence of characters to a unique number. In some examples, if there are 67 possible characters that can be included in the noncanonical communication, the processor can map each character in the previous sequence of characters to a unique number between 0 and 66. For example, if the previous sequence of characters includes the word “think,” the processor can map the letter “t” to the number “20” (because “t” is the 20^{th} word in the English alphabet), the letter “h” to the number “8,” the letter “i” to the number “9,” etc. The processor can repeat this process until each character in the word “think” is mapped to a unique number. The processor can use the unique numbers as the first set of encoded characters.

The processor can alternatively use other encoding schemes. For example, the processor can determine an encoding for each character in the previous sequence of characters using a neural network (e.g., the neural network of block 502). For example, during training, the neural network can learn a vector representation for each character. In some examples, the vector representation for a character can be 256 numbers long. The processor can map each character in the previous sequence of characters to a corresponding vector representation provided by the neural network.

In block 916, the processor transforms the noncanonical term into a second set of encoded characters. The processor can use any of the methods described with respect to block 914 to transform the noncanonical term into the second set of encoded characters. For example, the processor can map each character in the noncanonical term to a vector of numbers determined by a neural network.

In block 918, the processor transforms the later sequence of characters into a third set of encoded characters. The processor can use any of the methods described with respect to block 914 to transform the later sequence of characters into the third set of encoded characters. For example, the processor can map each character in the later sequence of characters to a vector of numbers determined by a neural network.

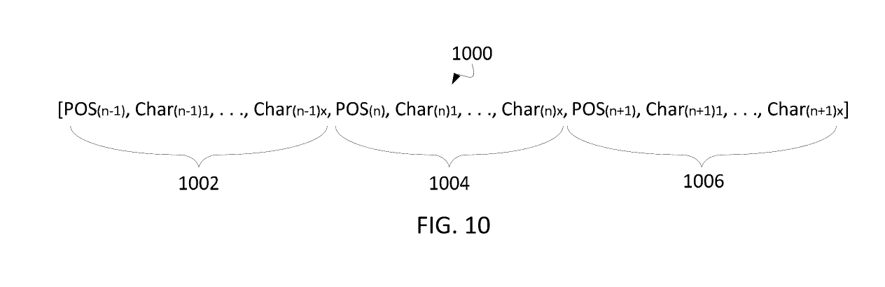

In block 920, the processor combines one or more of the first heading character, the first set of encoded characters, the second heading character, the second set of encoded characters, the third heading character, and the third set of encoded characters into a vector of characters. For example, the processor can concatenate the first heading character, the first set of encoded characters, the second heading character, the second set of encoded characters, the third heading character, and the third set of encoded characters, respectively, into the vector of characters. A representation of such a vector of characters is shown in FIG. 10. Referring to FIG. 10, vector components 1002 can be associated with the previous sequence of characters. For example, “POS₍ₙ₋₁₎” can represent the first heading character, and “Char₍ₙ₋₁₎, . . . , Char₍ₙ₋₁₎ₓ” can represent the first set of encoded characters. Vector components 1004 can be associated with the noncanonical term. For example, “POS₍ₙ₎” can represent the second heading character, and “Char₍ₙ₎₁, . . . , Char₍ₙ₎ₓ” can represent the second set of encoded characters. Vector components 1006 can be associated with the later sequence of characters. For example, “POS₍ₙ₊₁₎” can represent the third heading character, and “Char₍ₙ₊₁₎₁, . . . , Char₍ₙ₊₁₎ₓ” can represent the third set of encoded characters. In some examples, the total number of components in the vector of characters 1000 can be 3+x+y+z, where 3 can correspond to the three heading characters for the first POS, the second POS, and the third POS; x can represent a number of characters in the previous sequence of characters; y can represent a number of characters in the noncanonical term; and z can represent a number of characters in the later sequence of characters.

In some examples, the processor can additionally or alternatively determine other information associated with the previous sequence of characters, the noncanonical term, the later sequence of characters, or any combination of these. The processor can determine one or more heading characters representative of the other information. The processor can include the one or more heading characters in the vector of characters. For example, the processor can prepend, append, or otherwise integrate the one or more heading characters into the vector of characters. This can allow the processor to include more information or different information about the previous sequence of characters, the noncanonical term, the later sequence of characters, or any combination of these into the vector of characters.

In block 922, the processor can transmit the vector of characters to the neural network. For example, the processor can provide the vector of characters to an input layer of the neural network.

The neural network can receive the vector of characters at the input layer and use the vector of characters to determine one or more edit operations for converting the noncanonical communication into a normalized version of the noncanonical communication. In some examples, the neural network can be configured to determine the edit operations based on the first part of speech, the second part of speech, the third part of speech, or any combination of these. The neural network can additionally or alternatively be configured to determine the edit operations based on any other information associated with the previous sequence of characters, the noncanonical term, the later sequence of characters, or any combination of these represented within the vector of characters.

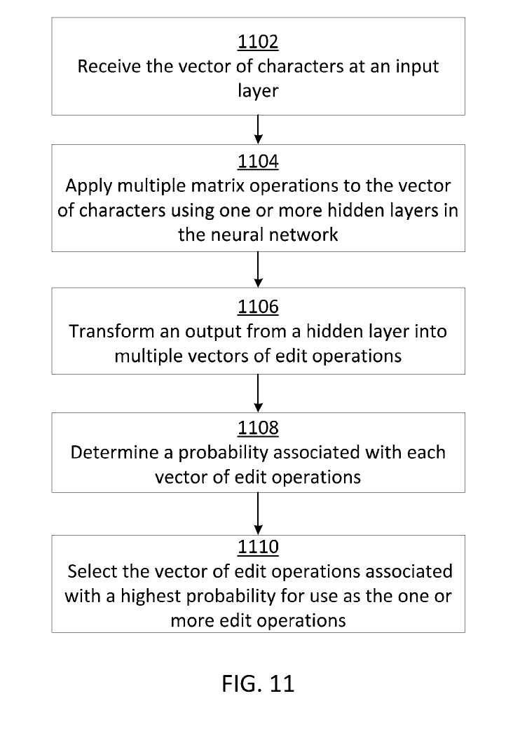

Referring back to FIG. 5, in block 520, the neural network determines edit operations for transforming the noncanonical communication into a normalized version of the noncanonical communication. The neural network can determine the edit operations according to one or more steps shown in FIG. 11.

Referring to FIG. 11, in block 1102, the neural network receives a vector of characters (e.g., determined in block 518) at an input layer.

In block 1104, the neural network applies matrix operations to the vector of characters via one or more hidden layers of the neural network. The neural network can include any number of hidden layers. Each hidden layer can include any number of neurons.

The neural network can apply the matrix operations to determine a minimum number of edit operations required to transform an input sequence of characters (e.g., associated with a noncanonical term) into a desired sequence of characters (e.g., associated with a candidate canonical form of the noncanonical term). In some examples, the edit operations can include deleting a character, replacing a character, and inserting a character.

In some examples, the matrix operations can include a Levenshtein distance calculation. The Levenshtein distance calculation can be used to determine a number of edit operations required to transform one sequence of characters into another sequence of characters. In some examples, the Levenshtein distance between two sequences of characters (which will be referred to as “a” and “b”) can determined according to the following equation:

$${lev}_{a , b} ( i , j ) = \{ \begin{matrix}max ( i , j ) & if min ( i , j ) = 0 \\ min \{ \begin{matrix}{lev}_{a , b} ( i - 1 , j ) + 1 \\ {lev}_{a , b} ( i , j - 1 ) + 1 \\ {lev}_{a , b} ( i - 1 , j - 1 ) + {1}_{( {a}_{i} \neq {b}_{j} )}\end{matrix} & otherwise .\end{matrix}$$

where i can be the number of characters in sequence of characters a, j can be the number of characters in sequence of characters b, and 1₍ₐ_{ᵢ}_{≠b}_{ⱼ}₎ can be an indicator function that is equal to 0 when aᵢ=bⱼ and equal to 1 when aᵢ≠bⱼ. Additionally, lev_{a,b}(i−1,j)+1 can represent a first edit operation (e.g., deleting a character), lev_{a,b}(i,j−1)+1 can represent a second edit operation (e.g., inserting a character), and lev_{a,b}(i−1,j−1)+1₍ₐ_{ᵢ}_{≠b}_{ⱼ}₎ can represent a third edit operation (e.g., replacing a character).

For example, the neural network can use the Levenshtein distance algorithm to determine a set of edit operations required to transform a sequence of characters associated with the noncanonical term into another sequences of characters associated with a potential canonical form of the noncanonical term. The neural network can repeat this process for all potential canonical forms of the noncanonical term.

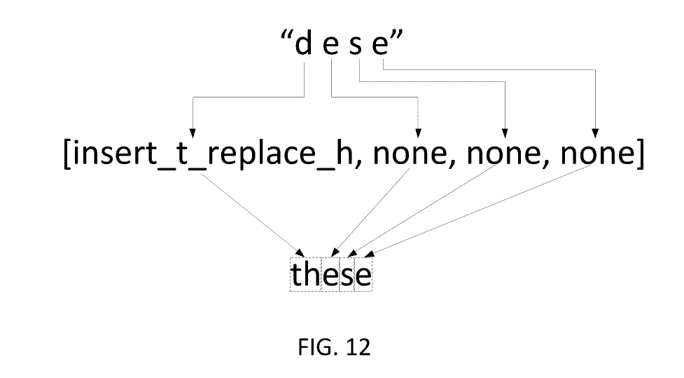

In block 1106, the neural network transforms an output from a hidden layer into multiple vectors of edit operations. Each vector of edit operations can include a single word-level edit operation (e.g., rather than multiple character-level edit operations). The single world-level edit operation can indicate all of the edit operations necessary to convert the noncanonical term into a corresponding candidate canonical term. For example, referring to FIG. 12, the neural network can determine that a vector of edit operations for transforming the noncanonical term “dese” into a canonical form “these” includes: [insert_t_replace_h, none, none, none]. The first component of the vector of edit operations, “insert_t_replace_h,” can represent a single word-level edit operation necessary to transform the noncanonical term “dese” into the canonical form “these.” The remaining “none” components in the vector can indicate that no change should be made to their corresponding characters in the noncanonical term “dese.” For example, the third “none” component in the vector can indicate that no change should be made to the letter “s” to transform “dese” into “these.” As another example, the neural network can determine that a vector of edit operations for transforming the noncanonical term “dey” into the canonical form “they” includes: [insert_t_replace_h, none, none].

In some examples, the “insert” edit operation can cause a character to be inserted prior to the corresponding character in the noncanonical term. For example, in the vector shown in FIG. 12, “insert_t_replace_h” is the first vector component, which can correspond to the character “d” in the noncanonical term “dey.” Thus, the “insert_t” edit operation can cause “t” to be inserted prior to the “d” in the noncanonical term (to transform the noncanonical term into the canonical form “they”). In some examples, to support insertions at the end of the noncanonical term, an empty character (e.g., a space) can be appended to the end of the noncanonical term during pre-processing (e.g., block 508 of FIG. 5). For example, a space can be appended to the noncanonical term “doin” to obtain the resulting noncanonical term “doin.” The neural network can determine the vector of edit operations [none, none, none, none, insert_g] to transform the noncanonical term “doin” into the canonical form “doing.”

In block 1108, the neural network determines a probability associated with each vector of edit operations. The neural network can determine the probability associated with each vector of edit operations by performing a softmax operation. The softmax operation can generate a probability for each vector of edit operations that can be represented as a value between zero and one, where the total of all of the values for all the vectors of edit operations can sum to one. In some examples, the softmax operation can be implemented using the following equation:

$${σ ( z )}_{j} = \frac{{e}^{z j}}{{\sum }_{k = 1}^{K} {e}^{zk}} for j = 1 , … , K$$

where σ(z)ⱼ is K-dimensional vector of real values in the range from 0 to 1, z is an input vector, k is a value in the vector, and K is a number of dimensions in the matrix.

In block 1110, the neural network selects the vector of edit operations associated with a highest probability for use as the one or more edit operations. For example, the neural network can order the probabilities from highest probability to lowest probability. The neural network can select the vector of edit operations associated with the highest probability for use as the one or more edit operations.

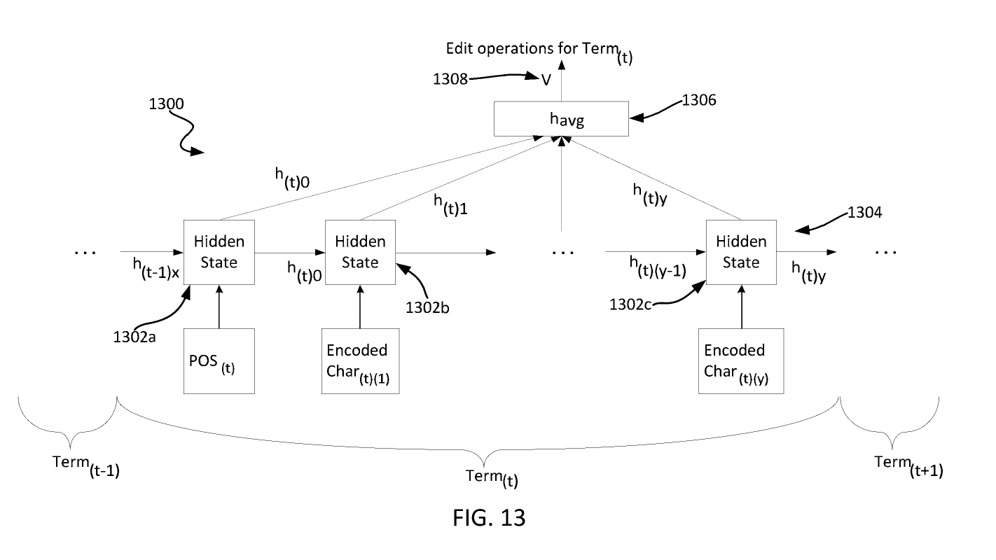

In some examples, the neural network can be represented according to the block diagram shown in FIG. 13. For simplicity, the block diagram only includes neural network components associated with Term₍ₜ₎ (e.g., a noncanonical term). But the neural network 1300 can include similar components for Term₍ₜ₋₁₎ (e.g., a previous string of characters to Term₍ₜ₎) and Term₍ₜ₊₁₎ (e.g., a subsequent string of characters to Term₍ₜ₎). In FIG. 13, at each time step, a POS heading character associated with Term₍ₜ₎, one or more encoded characters (e.g., from the vector of characters 1000 shown in FIG. 10) associated with Term₍ₜ₎, or both is fed into the neural network 1300. For example, during time step t shown in FIG. 13, POS₍ₜ₎ and Encoded Char₍ₜ₎₍₁₎ through Encoded Char_{(t)(y)}, can be fed into the neural network 1300 substantially simultaneously. This can generate one or more hidden states 1302a-c in one or more hidden layers 1304 of the neural network 1300. The neural network 1300 can then perform an average pooling using the hidden states. The result of the average pooling can be represented as h_{avg} 1306. The neural network 1300 can subsequently perform a softmax operation using h, 1306 multiplied by a weight matrix V 1308 to generate a transformed output that determines a probability associated with every possible edit operation combination. In some examples, the weight matrix V 1308 can be 256 components by 694 components, where 256 can be the number of dimensions used in the hidden state and 694 can be the total number of possible edit operations combinations. The transformed output can indicate one or more edit operations for converting Term₍ₜ₎ (e.g., a noncanonical term) into a normalized version of Term₍ₜ₎.

In some examples, the neural network 1300 can include a LSTM neural network with at least one self-connected memory cell. The neural network 1300 can include 256 hidden units to represent LSTM memory cell states and outputs. In some examples, the neural network 1300 can include a 25% dropout rate. A dropout rate can include a number or percentage of hidden neurons in hidden states 1302a-c of a neural network 1300 randomly excluded from consideration during training. In some examples, the neural network 1300 can be trained using gradient descent methods (e.g., AdaDelta) to optimize the neural network 1300, a cost function (e.g., negative-log likelihood), mini-batch based gradient descent (e.g., with a batch size of 16), or any combination of these.

Returning to FIG. 5, in block 522, the processor transforms the noncanonical communication into the normalized version of the noncanonical communication by performing the one or more edit operations. For example, the processor can transform the noncanonical communication “doin” into the normalized version “doing” by inserting a “g” at the end of “doin.”

In block 524, the processor includes the normalized version of the noncanonical communication in a data set. The data set can be used for textual analysis. For example, the data set can be configured to be analyzed to detect one or more characteristics or trends associated with the data set. In one example, the processor can include the normalized version of the noncanonical communication in a data set that includes multiple Twitter™ tweets. The data set can be analyzed using a textual analysis program to determine a customer sentiment about a brand indicated by the Twitter™ tweets.

The processor can also perform textual analysis on the data set, or the data set can be used as part of a textual analysis process. For example, the processor can use a textual analysis program (e.g., stored in memory) to analyze one or more characteristics of the data set to determine a trend, pattern, or other information indicated by the data set. The processor can provide such information to a user. Examples of such information can include a sentiment, such as a sentiment about a brand; an emotion, such as an emotion tied to a particular product launch; a statistic, such as a number of times a user posted about a particular product; a meme; an emoticon; etc.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A non-transitory computer readable medium comprising program code executable by a processor for causing the processor to:
receive an electronic representation of a plurality of characters that form a noncanonical communication;
determine that the noncanonical communication is mapped to at least two canonical terms in a database;
determine, using a recurrent neural network and based on determining that the noncanonical communication is mapped to the at least two canonical terms in the database, a vector of commands indicative of edit operations to be performed in a specific order for converting the noncanonical communication into a normalized version of the noncanonical communication, the edit operations comprising at least one of inserting a character into the noncanonical communication, deleting the character from the noncanonical communication, or replacing the character with another character in the noncanonical communication; and
transform the noncanonical communication into the normalized version of the noncanonical communication by performing the edit operations in the specific order;
wherein the recurrent neural network comprises:
a plurality of input-to-hidden connections for transforming input data into transformed input data and providing the transformed input data to a hidden layer at a current time step,
a plurality of hidden-to-hidden connections for transforming a hidden state of the hidden layer at a previous time step into a transformed hidden state and providing the transformed hidden state to the hidden layer at the current time step, and
a plurality of hidden-to-output connections for transforming the hidden state of the hidden layer at the current time step into a different transformed hidden state and transmitting the different transformed hidden state to an output layer at the current time step; and
wherein the recurrent neural network is configured to determine the normalized version of the noncanonical communication based on context information comprising a first part of speech corresponding to a previous sequence of characters positioned immediately prior to the noncanonical communication in the plurality of characters, a second part of speech corresponding to the noncanonical communication, and a third part of speech corresponding to a later sequence of characters positioned immediately following the noncanonical communication in the plurality of characters.

2. (canceled)

3. The non-transitory computer readable medium of claim 1, further comprising program code executable by the processor for causing the processor to:
prior to determining the vector of commands indicative of the edit operations using the recurrent neural network:
determine the first part of speech, the second part of speech, and the third part of speech using a part of speech tagger;
using a lookup table to map the first part of speech to a first heading character, the second part of speech to a second heading character, and the third part of speech to a third heading character;
transform the previous sequence of characters into a first plurality of encoded characters determined by the recurrent neural network, a sequence of characters from the noncanonical communication into a second plurality of encoded characters determined by the recurrent neural network, and the later sequence of characters into a third plurality of encoded characters determined by the recurrent neural network; and
concatenate the first heading character, the first plurality of encoded characters, the second heading character, the second plurality of encoded characters, the third heading character, and the third plurality of encoded characters, respectively, into a single vector of characters usable as an input for the recurrent neural network.

4. The non-transitory computer readable medium of claim 3, further comprising program code executable by the processor for causing the processor to:
determine that the noncanonical communication is mapped to the at least two canonical terms in the database by:
automatically generating the database using a labeled dataset, wherein the database comprises a plurality of noncanonical terms mapped to a plurality of canonical terms, each noncanonical term of the plurality of noncanonical terms being mapped to one or more corresponding canonical terms of the plurality of canonical terms; and
determining that the noncanonical communication is mapped to the at least two canonical terms in the plurality of canonical terms; and
based on determining that the noncanonical communication is mapped to the at least two canonical terms in the database, provide the single vector of characters to the recurrent neural network for determining the vector of commands indicative of the edit operations.

5. The non-transitory computer readable medium of claim 4, wherein the recurrent neural network is configured to:
receive the single vector of characters at an input layer;
apply a plurality of matrix operations to the single vector of characters using one or more hidden layers of the recurrent neural network, wherein the one or more hidden layers each comprise a layer of units between the input layer and the output layer of the recurrent neural network;
transform an output of the one or more hidden layers into a plurality of values that sum to a total value of one, each value of the plurality of values being a number between zero and one and representing a probability of a sequence of edit operations correctly converting the noncanonical communication into the normalized version; and
determine the vector of commands indicative of the edit operations based on the plurality of values by selecting the sequence of edit operations associated with a highest probability.

6. The non-transitory computer readable medium of claim 5, wherein the plurality of matrix operations comprises an edit operation calculation based on a Levenshtein distance.

7. The non-transitory computer readable medium of claim 3, wherein the recurrent neural network is configured to automatically generate the first plurality of encoded characters, the second plurality of encoded characters, and the third plurality of encoded characters during a training operation.

8. The non-transitory computer readable medium of claim 1, further comprising program code executable by the processor for causing the processor to:
subsequent to determining the vector of commands indicative of the edit operations:
remove, from the vector of commands, a command that indicates no change should be made to a particular character in the noncanonical communication.

9. The non-transitory computer readable medium of claim 1, wherein each command in the vector of commands is indicative of a particular edit operation to be performed with respect to an associated character in the noncanonical communication for converting the noncanonical communication into the normalized version of the noncanonical communication.

10. The non-transitory computer readable medium of claim 1, further comprising program code executable by the processor for causing the processor to:
include the normalized version of the noncanonical communication in a data set for use in textual analysis; and
perform textual analysis on the data set to determine one or more trends indicated by the data set.

11. A method comprising:
receiving an electronic representation of a plurality of characters that form a noncanonical communication;
determining that the noncanonical communication is mapped to at least two canonical terms in a database;
based on determining that the noncanonical communication is mapped to the at least two canonical terms in the database, use a recurrent neural network to determine a vector of commands indicative of edit operations to be performed in a specific order for converting the noncanonical communication into a normalized version of the noncanonical communication, the edit operations comprising at least one of inserting a character into the noncanonical communication, deleting the character from the noncanonical communication, or replacing the character with another character in the noncanonical communication; and
transforming the noncanonical communication into the normalized version of the noncanonical communication by performing the edit operations in the specific order:
wherein the recurrent neural network comprises:
a plurality of input-to-hidden connections for transforming input data into transformed input data and providing the transformed input data to a hidden layer at a current time step,
a plurality of hidden-to-hidden connections for transforming a hidden state of the hidden layer at a previous time step into a transformed hidden state and providing the transformed hidden state to the hidden layer at the current time step, and
a plurality of hidden-to-output connections for transforming the hidden state of the hidden layer at the current time step into a different transformed hidden state and transmitting the different transformed hidden state to an output layer at the current time step; and
wherein the recurrent neural network is configured to determine the normalized version of the noncanonical communication based on context information comprising a first part of speech corresponding to a previous sequence of characters positioned immediately prior to the noncanonical communication in the plurality of characters, a second part of speech corresponding to the noncanonical communication, and a third part of speech corresponding to a later sequence of characters positioned immediately following the noncanonical communication in the plurality of characters.

12. (canceled)

13. The method of claim 1, further comprising:
prior to determining the vector of commands indicative of the edit operations using the recurrent neural network:
determining the first part of speech, the second part of speech, and the third part of speech using a part of speech tagger;
using a looking table to ma the first part of speech to a first heading character, the second part of speech to a second heading character, and the third part of speech to a third heading character;
transforming the previous sequence of characters into a first plurality of encoded characters determined by the recurrent neural network, a sequence of characters from the noncanonical communication into a second plurality of encoded characters determined by the recurrent neural network, and the later sequence of characters into a third plurality of encoded characters determined by the recurrent neural network; and
concatenating the first heading character, the first plurality of encoded characters, the second heading character, the second plurality of encoded characters, the third heading character, and the third plurality of encoded characters, respectively, into a single vector of characters usable as an input for the recurrent neural network.

14. The method of claim 13, further comprising:
determining that the noncanonical communication is mapped to the at least two canonical terms in the database by:
automatically generating the database using a labeled dataset, wherein the database comprises a plurality of noncanonical terms mapped to a plurality of canonical terms, each noncanonical term of the plurality of noncanonical terms being mapped to one or more corresponding canonical terms of the plurality of canonical terms; and
determining that the noncanonical communication is mapped to the at least two canonical terms in the plurality of canonical terms; and
based on determining that the noncanonical communication is mapped to the at least two canonical terms in the database, providing the single vector of characters to the recurrent neural network for determining the vector of commands indicative of the edit operations.

15. The method of claim 14, wherein the recurrent neural network:
receives the single vector of characters at an input layer;
applies a plurality of matrix operations to the single vector of characters using one or more hidden layers of the recurrent neural network, wherein the one or more hidden layers each comprise a layer of units between the input layer and the output layer of the recurrent neural network;
transforms an output of the one or more hidden layers into a plurality of values that sum to a total value of one, each value of the plurality of values being a number between zero and one and representing a probability of a sequence of edit operations correctly converting the noncanonical communication into the normalized version; and
determines the vector of commands indicative of the edit operations based on the plurality of values by selecting the sequence of edit operations associated with a highest probability.

16. The method of claim 15, wherein the plurality of matrix operations comprises an edit operation calculation based on a Levenshtein distance.

17. The method of claim 13, wherein the recurrent neural network is configured to automatically generate the first plurality of encoded characters, the second plurality of encoded characters, and the third plurality of encoded characters during a training operation.

18. The method of claim 11, further comprising:
subsequent to determining the vector of commands indicative of the edit operations:
removing, from the vector of commands, a command that indicates no change should be made to a particular character in the noncanonical communication.

19. The method of claim 11, wherein each command in the vector of commands is indicative of a particular edit operation to be performed with respect to an associated character in the noncanonical communication for converting the noncanonical communication into the normalized version of the noncanonical communication.

20. The method of claim 11, further comprising:
including the normalized version of the noncanonical communication in a data set for use in textual analysis; and
performing textual analysis on the data set to determine one or more trends indicated by the data set.

21. A system comprising:
a processing device; and
a memory device in which instructions executable by the processing device are stored for causing the processing device to:
receive an electronic representation of a plurality of characters that form a noncanonical communication;
determine that the noncanonical communication is mapped to at least two canonical terms in a database;
determine, using a recurrent neural network and based on determining that the noncanonical communication is mapped to the at least two canonical terms in the database, a vector of commands indicative of edit operations to be performed in a specific order for converting the noncanonical communication into a normalized version of the noncanonical communication, the edit operations comprising at least one of inserting a character into the noncanonical communication, deleting the character from the noncanonical communication, or replacing the character with another character in the noncanonical communication; and
transform the noncanonical communication into the normalized version of the noncanonical communication by performing the edit operations in the specific order;
wherein the recurrent neural network comprises:
a plurality of input-to-hidden connections for transforming input data into transformed input data and providing the transformed input data to a hidden layer at a current time step,
a plurality of hidden-to-hidden connections for transforming a hidden state of the hidden layer at a previous time step into a transformed hidden state and providing the transformed hidden state to the hidden layer at the current time step, and
a plurality of hidden-to-output connections for transforming the hidden state of the hidden layer at the current time step into a different transformed hidden state and transmitting the different transformed hidden state to an output layer at the current time step; and
wherein the recurrent neural network is configured to determine the normalized version of the noncanonical communication based on context information comprising a first part of speech corresponding to a previous sequence of characters positioned immediately prior to the noncanonical communication in the plurality of characters, a second part of speech corresponding to the noncanonical communication, and a third part of speech corresponding to a later sequence of characters positioned immediately following the noncanonical communication in the plurality of characters.

22. (canceled)

23. The system of claim 21, wherein the memory device further comprises instructions executable by the processing device for causing the processing device to:
prior to determining the vector of commands indicative of the edit operations using the recurrent neural network:
using a lookup table to map the first part of speech to a first heading character, the second part of speech to a second heading character, and the third part of speech to a third heading character;
transform the previous sequence of characters into a first plurality of encoded characters determined by the recurrent neural network, a sequence of characters from the noncanonical communication into a second plurality of encoded characters determined by the recurrent neural network, and the later sequence of characters into a third plurality of encoded characters determined by the recurrent neural network; and
concatenate the first heading character, the first plurality of encoded characters, the second heading character, the second plurality of encoded characters, the third heading character, and the third plurality of encoded characters, respectively, into a single vector of characters usable as an input for the recurrent neural network.

24. The system of claim 23, wherein the memory device further comprises instructions executable by the processing device for causing the processing device to:
determine that the noncanonical communication is mapped to the at least two canonical terms in the database by:
automatically generating the database using a labeled dataset, wherein the database comprises a plurality of noncanonical terms mapped to a plurality of canonical terms, each noncanonical term of the plurality of noncanonical terms being mapped to one or more corresponding canonical terms of the plurality of canonical terms; and
determining that the noncanonical communication is mapped to the at least two canonical terms in the plurality of canonical terms; and
based on determining that the noncanonical communication is mapped to the at least two canonical terms in the database, provide the single vector of characters to the recurrent neural network for determining the vector of commands indicative of the edit operations.

25. The system of claim 24, wherein the recurrent neural network is configured to:
receive the single vector of characters at an input layer;
apply a plurality of matrix operations to the single vector of characters using one or more hidden layers of the recurrent neural network, wherein the one or more hidden layers each comprise a layer of units between the input layer and the output layer of the recurrent neural network;
transform an output of the one or more hidden layers into a plurality of values that sum to a total value of one, each value of the plurality of values being a number between zero and one and representing a probability of a sequence of edit operations correctly converting the noncanonical communication into the normalized version; and
determine the vector of commands indicative of the edit operations based on the plurality of values by selecting the sequence of edit operations associated with a highest probability.

26. The system of claim 25, wherein the plurality of matrix operations comprises an edit operation calculation based on a Levenshtein distance.

27. The system of claim 23, wherein the recurrent neural network is configured to automatically generate the first plurality of encoded characters, the second plurality of encoded characters, and the third plurality of encoded characters during a training operation.

28. The system of claim 21, wherein the memory device further comprises instructions executable by the processing device for causing the processing device to:
subsequent to determining the vector of commands indicative of the edit operations:
remove, from the vector of commands, a command that indicates no change should be made to a particular character in the noncanonical communication.

29. The system of claim 21,
wherein each command in the vector of commands is indicative of a particular edit operation to be performed with respect to an associated character in the noncanonical communication for converting the noncanonical communication into the normalized version of the noncanonical communication.

30. The system of claim 21, wherein the memory device further comprises instructions executable by the processing device for causing the processing device to:
include the normalized version of the noncanonical communication in a data set for use in textual analysis; and
perform textual analysis on the data set to determine one or more trends indicated by the data set.
